(19) United States
(12) Patent Application Publication
(10) Pub. No.: US 2014/0078534 A1
(43) Pub. Date: Mar. 20, 2014

(54) PRINT CONDITION RECOMMENDATION DEVICE, PRINT PROCESSING APPARATUS, PRINT CONDITION RECOMMENDATION METHOD AND TANGIBLE COMPUTER-READABLE RECORDING MEDIUM

(71) Applicant: KONICA MINOLTA, INC., Chiyoda-ku (JP)

(72) Inventor: Akihiko ODA, Toyohashi-shi (JP)

(73) Assignee: KONICA MINOLTA, INC., Chiyoda-ku (JP)

(21) Appl. No.: 14/018,522

(22) Filed: Sep. 5, 2013

(30) Foreign Application Priority Data
Sep. 18, 2012 (JP) 2012-203861

(51) Int. Cl. G06K 15/02

(52) U.S. Cl. CPC G06K 15/1809
USPC 358/1.13; 358/1.15

(57) ABSTRACT

Disclosed is a print condition recommendation device, including: a result recording unit to record a print condition used in printing carried out by a predetermined print apparatus, and result information which is one of a result value of each of a plurality of saving items which are previously determined and data for calculating the result value, so as to relate the print condition to the result information; a selection receiving unit to receive a selection of a prior saving item among the saving items from a user; a recommendation print condition determining unit to determine a recommendation print condition which increases a saving effect of the prior saving item, in accordance with the result information; and a recommendation print condition reflecting unit to show the recommendation print condition to the user, or to set the recommendation print condition to the predetermined print apparatus.

### BACKGROUND OF THE INVENTION

1. Field of the Invention

The present invention relates to a print condition recommendation device, a print processing apparatus, a print condition recommendation method and a tangible computer-readable recording medium for recommending a suitable print condition in view of the energy saving.

2. Description of Related Art

In view of the prevention of the global warming and the energy saving, it is required to suppress the electric power consumption. Further, in many companies, because of the cost reduction, the energy saving for copy machines and printers is required. In such a situation, the following approach is adopted. A copy machine or a printer measures and indicates the electric energy which is used in a main body of the copy machine or the printer, and the consciousness of the energy saving and the interest in the emission amount of carbon dioxide are enhanced in each company to promote the activity for the ecology.

Further, there has been a print management device which previously sets the print condition which contributes to the ecology among the print conditions to be set to a printer driver. In the print management device, the comparison result between the set print condition and a print condition which is actually used, is managed as log data (Japanese Patent Application Publication No. 2011-118817).

However, only the indication of the electric energy which is actually consumed is not sufficient for the enlightenment of the energy saving. Even though a user looks at the indicated amount of consumed power, the user cannot judge whether the indicated amount of consumed power is a proper value. Further, the user cannot judge whether the additional energy saving can be carried out.

Further, the final output, such as the printing cost, the amount of consumed power, the emission amount of carbon dioxide and the like, is complexly influenced by a plurality of elements. The user cannot easily specify the print parameter which influences the above final output, among the print parameters which are set by the user. As a result, the user cannot easily change the print parameter to a suitable one.

Further, even though the user grasps the optimal print conditions, the setting change operations for reflecting these print conditions on actual print conditions are complicated, and cannot be easily carried out.

The resources for printing and the printing cost (fees for paper and toner, electricity charges, maintenance fee and the like) are largely changed according to the conditions of purchase and the conditions of contract in each company or in each working place. As a result, depending on the resources for printing and the printing cost, the optimal print conditions are changed according to each company or each working place. Therefore, the user can hardly change the print setting to a suitable one in view of the resources for printing and the printing cost.

In the above Japanese Patent Application Publication, because the prior print condition is previously set as the print condition which contributes to the resource saving and the energy saving, it is not possible to handle the saving item which matches with user's demand or request, for example, the suppression of the total cost including the maintenance fee, the saving of the paper resource, and the like. Further, although it is necessary to previously set the optimal print condition, it is difficult to judge the optimal print condition to be set. Further, although the optimal print condition is fixedly set, because the optimal print condition changes depending on the environments, the cost of the electric power and the material, and the like, there are some cases in which the fixed optimal print condition is practically not the optimal one.

### SUMMARY

To achieve at least one of the abovementioned objects, a print condition recommendation device reflecting one aspect of the present invention comprises:

a result recording unit to record a print condition used in printing carried out by a predetermined print apparatus, and result information which is one of a result value of each of a plurality of saving items which are previously determined and data for calculating the result value, so as to relate the print condition to the result information;

a selection receiving unit to receive a selection of a prior saving item among the plurality of saving items from a user;

a recommendation print condition determining unit to determine a recommendation print condition which is the print condition which increases a saving effect of the prior saving item received by the selection receiving unit, in accordance with the result information recorded in the result recording unit; and

a recommendation print condition reflecting unit to show the recommendation print condition determined by the recommendation print condition determining unit, to the user, or to set the recommendation print condition to the predetermined print apparatus.

Preferably, the plurality of saving items include at least two items selected among consumed power, toner, recording paper, total cost and emission amount of carbon dioxide.

Preferably, the recommendation print condition determining unit selects one or more print parameters having high degree of influence on change in the result value of the saving item received by the selection receiving unit, in accordance with the result information recorded in the result recording unit, and calculates a value of each selected print parameter, which optimizes the result value, as the recommendation print condition.

Preferably, the print condition recommendation device further comprises a driver setting unit to transmit the recommendation print condition to a predetermined printer driver and to set the recommendation print condition to the predetermined printer driver as a default print condition.

Preferably, the recommendation print condition determining unit determines the recommendation print condition within an allowable range which is previously set.

Preferably, the result recording unit records the print condition used in the printing carried out by each of a plurality of print apparatuses connected via a network and the result information obtained by the printing, so as to relate the print condition to the result information.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a block diagram showing the electrical schematic structure of the print processing apparatus according to the first embodiment;

FIG. 2 is a view showing the process sequence in case that the print processing apparatus according to the first embodiment receives a print job from a user PC connected to a network and carries out printing;

FIG. 3 is a view showing an example of the registered contents of the print result DB;

FIG. 4 is a view showing the registered contents of the print result DB, which are the same as those of FIG. 3, and in which the parameters relating to the calculation of the total cost are shown in gray;

FIG. 5 is a view showing the registered contents of the print result DB, which are the same as those of FIG. 3, and in which the parameters relating to the calculation of the total consumed power are shown in gray;

FIG. 6 is a view showing the registered contents of the print result DB, which are the same as those of FIG. 3, and in which the parameters relating to the calculation of the amount of toner consumption are shown in gray;

FIG. 7 is an explanatory view showing the method for calculating the contribution degree of the recording paper size to the total cost;

FIG. 8 is a view showing the contribution degree of each parameter to the total cost by the radar chart;

FIG. 9 is a graph showing the relations between the recording paper size and the total cost, which are calculated for the plain paper and the recycled paper, respectively, from the result values and the like stored in the print result DB;

FIG. 10 is a graph showing the relations between the color/monochrome mode and the total cost, which are calculated for the respective recording paper sizes from the result values and the like stored in the print result DB;

FIG. 11 is a graph showing the relations between the one-side printing/two-side printing mode and the total cost, which are calculated for A3 recycled paper, A3 plain paper, A4 recycled paper and A4 plain paper, respectively, from the result values and the like stored in the print result DB;

FIG. 12 is a view showing the process sequence in case that the print processing apparatus according to the second embodiment receives a print job from a user PC connected to a network and carries out printing;

FIG. 13 is a view showing the process sequence in case that the print processing apparatus according to the third embodiment receives a print job from a user PC connected to a network and carries out printing;

FIG. 14 is a view showing an example of the printing system according to the fourth embodiment;

FIG. 15 is a block diagram showing the electrical schematic structure of the management server;

FIG. 16 is a view showing the process sequence in case that printing is carried out in the print system according to the fourth embodiment;

FIG. 17 is a view showing the process sequence in case that printing is carried out by the first print processing apparatus according to the fifth embodiment; and

FIG. 18 is a view showing another example of the process sequence in case that printing is carried out by the first print processing apparatus according to the fifth embodiment.

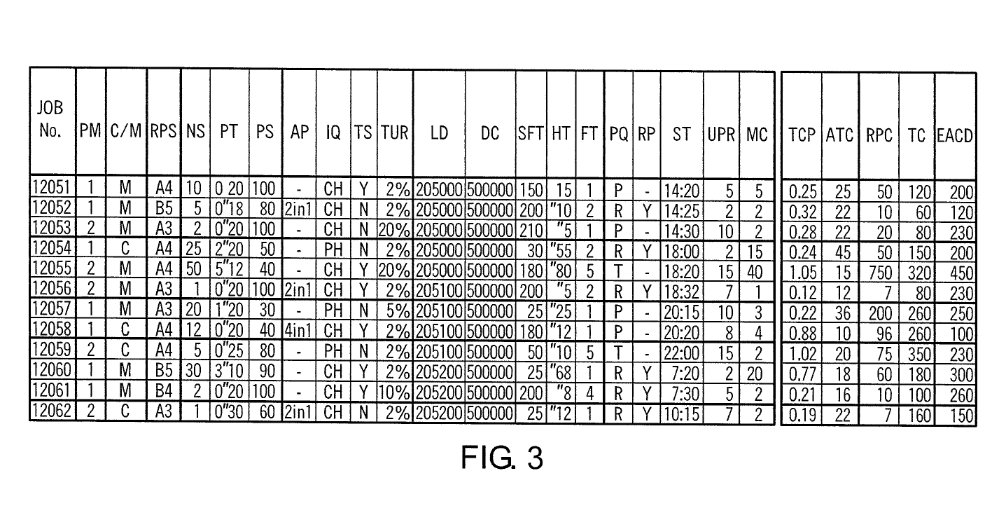

In FIGS. 3-6, the abbreviations in the headings represent the following terms:

PM: PRINT MODE; C/M: COLOR/MONOCHROME; RPS: RECORDING PAPER SIZE; NS: NUMBER OF SHEETS; PT: PRINTING TIME; PS: PRINTING SHEED; AP: AGGREGATE PRINT; IQ: IMAGE QUALITY (CH: CHARACTER; PH:PHOTOGRAPH); TS: TONER SAVE; TUR: TONER USAGE RATE; LD; LIFE OF DEVELOPER; DC: DRUM COUNT; SFT: STARTING FIXING TEMPERATURE; HT: HEATER ON TIME; FT: FEED TRAY; PQ: PAPER QUALITY (P: PLAIN PAPER; R: RECYCLED PAPER; T: THICK PAPER); RP: RECYCLED PAPER; ST: STARTING TIME; UPR: UNIT PRICE OF RECORDING PAPER; MC: MAINTENANCE COST

### TCP: TOTAL CONSUMED POWER; ATC: AMOUNT OF TONER CONSUMPTION; RPC: RECORDING PAPER COST; TC: TOTAL COST; EACD: EMISSION AMOUNT OF CARBON DIOXIDE

### DETAILED DESCRIPTION OF PREFERRED EMBODIMENTS

Hereinafter, preferred embodiments of the present invention will be explained with reference to the accompanying drawings.

### First Embodiment

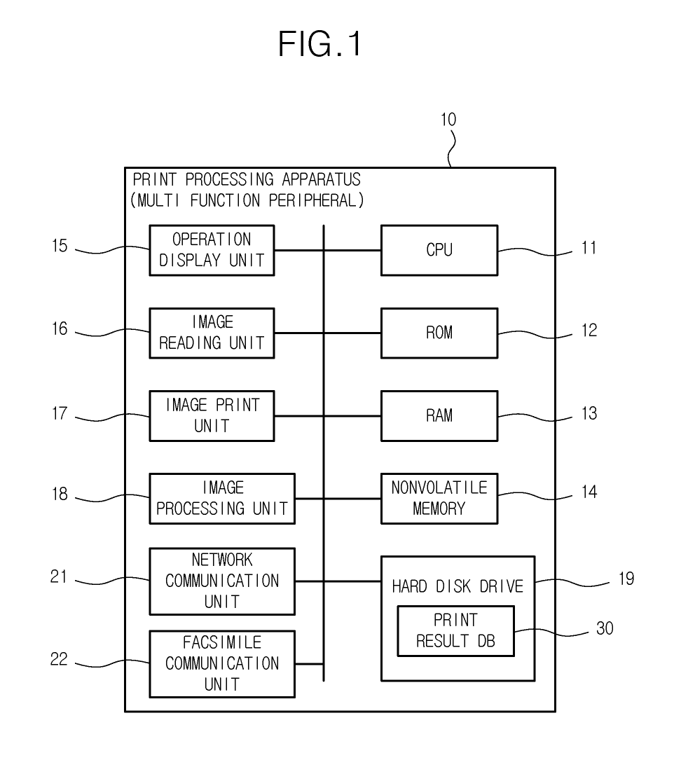

FIG. 1 shows the electrical schematic structure of the print processing apparatus 10 according to the first embodiment. In this embodiment, the print processing apparatus 10 is constructed as a multi function peripheral having a copy function of optically reading an original image to print the read image on recording paper, a scan function of obtaining image data by reading an original to store the obtained image data as a file or to transmit the obtained image data to an external terminal, a print function of forming an image on recording paper in accordance with image data of a print job received from an external terminal, such as a personal computer, or a print server, a facsimile function of transmitting and receiving image data, and the like. However, as long as the print processing apparatus 10 has at least the print function, it is not necessary that the print processing apparatus 10 has another function. Further, the print processing apparatus 10 functions as the print condition recommendation device.

In the print processing apparatus 10, a CPU (Central Processing Unit) 11 for controlling the operation of the print processing apparatus 10, is connected with a ROM (Read Only Memory) 12, a RAM (Random Access Memory) 13, a nonvolatile memory 14, an operation display unit 15, an image reading unit 16, an image print unit 17, an image processing unit 18, a hard disk drive 19, a network communication unit 21, a facsimile communication unit 22 and the like via a bus.

In the ROM 12, various types of programs and data are stored. By executing various types of processes by the CPU 11 in accordance with these programs, various types of functions of the print processing apparatus 10 are realized. The RAM 13 is used as a work memory for temporarily storing various types of data when the CPU 11 executes the programs.

The nonvolatile memory 14 is a memory in which the stored contents are held even if the print processing apparatus 10 is turned off. In the nonvolatile memory 14, various types of setting information, user information, communication information (network addresses and the like) and the like are stored.

The operation display unit 15 has a function of displaying various types of operation windows and setting windows for operating the print processing apparatus 10, and a function of receiving various types of operations from a user. The operation display unit 15 comprises a liquid crystal display and a touch panel for detecting a touch operation to a display surface of the liquid crystal display. Further, the operation display unit 15 comprises operation switches, such as a start button and the like. Further, the operation display unit 15 has a function as the selection receiving unit for receiving the selection of a prior saving item among a plurality of saving items which will be described below, from a user.

The image reading unit 16 obtains an image data by optically reading an original image. For example, the image reading sensor 16 comprises a light source for irradiating an original with light, a line image sensor for reading the original line by line in the width direction of the original by receiving the reflected light from the original, an optical system having lenses, mirrors and the like for guiding the reflected light from the original to the line image sensor and focusing the reflected light on the line image sensor, a moving mechanism for sequentially moving the reading position line by line in the longitudinal direction of the original by moving the mirrors and the light source, and the like.

The image print unit 17 forms an image in accordance with image data to print out it on the recording paper by the electrophotographic process. That is, the image print unit 17 has a function as the print unit of the print processing apparatus 10. The image print unit 17 is configured as the engine unit of the so-called laser printer, which comprises a conveying device for the recording paper, a photoconductive drum, a charging device, an LD (Laser Diode) of which the light emission is controlled in accordance with the input image data, a scanning unit for scanning the photoconductive drum by using the laser light emitted from the LD, a developing device, a transfer and separation device, a cleaning device and a fixing device. Alternatively, the image print unit 17 may be configured by an LED (Light Emitting Diode) printer in which the photoconductive drum is irradiated by LED instead of the laser light, or may be another type of printer.

The image processing unit 18 carries out various types of image processings, such as image correction, rotation, enlargement/reduction, compression/decompression and the like, for the image data.

The hard disk drive 19 is a nonvolatile memory device having large capacity, and is used for storing image data obtained by reading an original with the image reading unit 16, print data received from an external PC (Personal Computer) or the like, image data received via the facsimile communication, and the like. Further, the hard disk drive 19 is used as a result recording unit which provides the print result DB (Database) 30 for recording the result information and the like, which will be described below.

The network communication unit 21 has a function of communicating with other print processing apparatuses, various types of external devices and a server, via the network. The facsimile communication unit 22 carries out the facsimile communication by the protocol control relating to the facsimile communication.

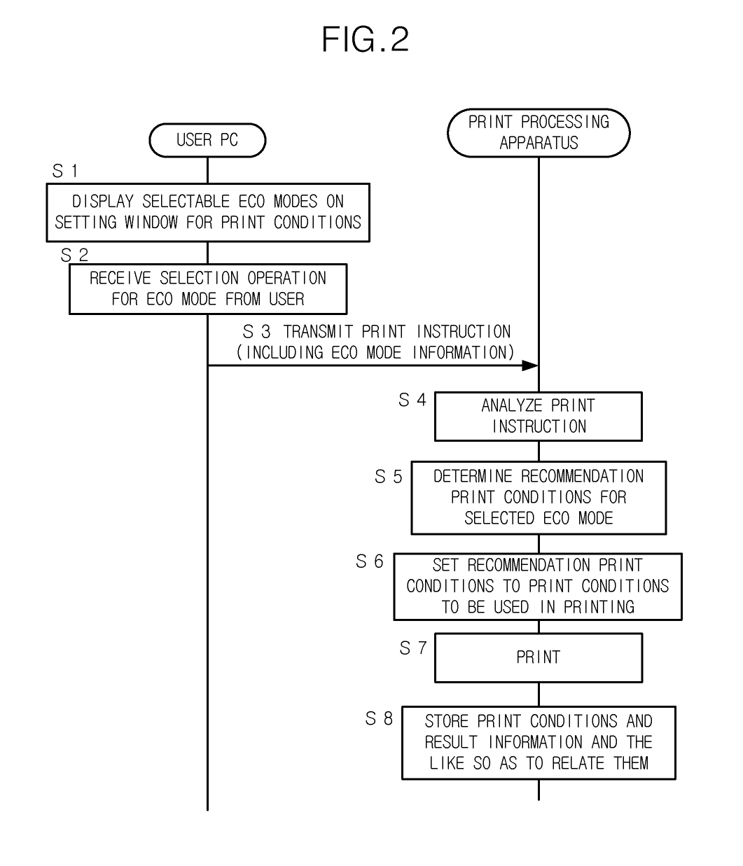

FIG. 2 shows the process sequence in case that the print processing apparatus 10 according to the first embodiment receives a print job from a terminal device (hereinafter, referred to as “user PC”) connected to the network and carries out printing.

In the user PC, the printer driver which is compliant with the print processing apparatus 10 is installed. When a user who operates the user PC instructs the print processing apparatus 10 to print a file or the like, the user sets one or more print conditions to the setting window (printer driver window) displayed by the printer driver. At this time, the printer driver displays a plurality of selectable saving items on the setting window for setting the print conditions (S1). In this embodiment, the saving items include the total consumed power which is one of the saving items relating to the consumed power, the amount of toner consumption which is one of the saving items relating to the toner, the recording paper cost which is one of the saving items relating to the recording paper, the total cost and the emission amount of carbon dioxide.

The mode in which the print processing apparatus 10 operates so as to adjust the value of each saving item (the value relating to the consumed power, the cost or the like) to the optimal value (normally, smaller value) during the printing, is referred to as the eco mode. The eco modes include the consumed power saving priority mode in which the total consumed power is preferentially reduced, the toner saving priority mode in which the amount of toner consumption is preferentially reduced, the recording paper saving priority mode in which the recording paper cost is preferentially reduced, the total cost saving priority mode in which the total cost is preferentially reduced, and the carbon dioxide emission saving priority mode in which the emission amount of carbon dioxide is preferentially reduced.

The printer driver of the user PC receives the selection operation for selecting one eco mode among the above-described eco modes, from the user (S2). When the printer driver receives the instruction for starting the printing from the user, the printer driver of the user PC transmits the print instruction including the information indicating the selected eco mode to the print processing apparatus 10 (S3).

The network communication unit 21 of the print processing apparatus 10 receives the print instruction including the information indicating the selected eco mode, from the user PC. That is, the network communication unit 21 has a function as the selection receiving unit for receiving the selection of the prior eco mode (saving item) among a plurality of eco modes (saving items), from the user PC (user). The CPU 11 of the print processing apparatus 10 analyzes the received print instruction (S4), and determines one or more print conditions which are the most suitable for the eco mode selected by the user (which increase the saving effect of the selected saving item) (hereinafter, referred to as “recommendation print condition(s)”), in accordance with the result information and the like which is obtained by the printing carried out for a certain term and is stored in the print result DB 30 of the print processing apparatus 10 (S5). That is, the CPU 11 functions as the recommendation print condition determining unit. Further, the CPU 11 sets the determined recommendation print conditions as the print conditions to be used in the printing (S6). That is, the CPU 11 functions as the recommendation print condition reflecting unit for setting the above recommendation print conditions to the image print unit 17. The image print unit 17 carries out the printing under the recommendation print conditions (S7).

When the printing is finished, the print processing apparatus 10 relates the print conditions used in the printing to the result information for all of the eco modes, which is obtained by the printing, and stores the print conditions and the result information in the print result DB 30 of the hard disk drive 19 as the result recording unit of the print processing apparatus 10 (S8).

The result information is the information including one of the result value of the saving item corresponding to each eco mode and the basic data for calculating the result value, or the information including both of the result value and the basic data. It may be optionally selected whether the result value is stored or the basic data necessary for calculating the result value are stored. Further, in one eco mode, the result value may be stored, and in another eco mode, the basic data for calculating the result value may be stored.

In the basic data for calculating the result value of the saving item, there are setting values of the printing and result values relating to the subordinate items necessary for calculating the result value of the saving item. For example, in case that the result value of the recording paper cost is calculated from the unit price of the recording paper and the number of sheets used in the printing, and the unit price of the recording paper is determined from the recording paper size, the recording paper size is the setting value for calculating the result value of the recording paper cost. The number of the sheet is the subordinate item for calculating the result value of the recording paper cost.

As described above, the print processing apparatus 10 according to the first embodiment, automatically determines the recommendation print conditions for the eco mode selected by the user, in accordance with the result values and the like which are obtained by the printing carried out for a certain term, to carry out the printing by using the determined recommendation print conditions. Therefore, by only selecting the eco mode, the user can instruct the print processing apparatus 10 to carry out the printing under the print conditions which are the most suitable for the selected eco mode. It is not necessary to carry out the detail setting of each print condition. The troublesome task for setting the print conditions is reduced. Further, because the recommendation print conditions are determined in accordance with the result values of the past printing, the optimal print conditions according to the actual usage situation are determined as the recommendation print conditions.

The above certain term can be optionally set and changed. For example, the certain term can be set to the fixed term, such as one month, three months or the like, or set to the entire period since the print processing apparatus 10 is set up (or since the print processing apparatus 10 is reset).

Next, the registered contents of the print result DB 30 in which the print conditions of the printing carried out for a certain term and the result information are registered so as to relate them to each other, will be explained.

FIG. 3 shows an example of the registered contents of the print result DB 30. In the print result DB 30, the values of the items, such as job number (JOB No.), print mode (1), color/monochrome (1), recording paper size (1), the number of sheets used in the printing (2), printing time (2), printing speed (2), aggregate print (1), image quality (1), toner save (1), toner usage rate (2), life of developer (2), drum count (2), starting fixing temperature (2), heater ON time (2), feed tray (1), paper quality (1), recycled paper (1), starting time (2), unit price of recording paper (3), maintenance cost (2), and the like, are recorded for each print job.

The values of the above items are classified into 1: setting value, 2: result value and 3: registered value. In each of the above parentheses, the classification number is entered. The setting value indicates the print condition (the value of the print parameter) which is set at the printing. The result value is a result value of the subordinate item for calculating the result value of each eco mode (saving item). The registered value indicates the unit price or the like, and each registered value is defined by the contract or the like.

The print mode indicates one-side printing or two-side printing. The value “1” of the print mode indicates the one-side printing, and the value “2” indicates the two-side printing. The color/monochrome indicates color printing or monochrome printing. The value “C” of the color/monochrome indicates the color printing, and the value “M” indicates the monochrome printing. The toner usage rate indicates the rate of the part on which any of the toners is used, to one page. The life of developer indicates the count value of the number of times that the copies are carried out by using the identical developer. Because the developer is deteriorated in every printing, it is necessary to change the developer when the count value reaches a predetermined value. As a result, the maintenance cost is caused. The drum count indicates the count value of the number of times that the copies are carried out by using the identical drum. Because the photoconductive drum is deteriorated according to the number of times that the drum is used, it is necessary to change the drum when the count value reaches a predetermined value. As a result, the maintenance cost is caused.

The starting fixing temperature indicates the temperature of the fixing device at the timing of starting the printing. In case that the above temperature is low, it is necessary to warm up the fixing device. Therefore, in order to warm up the fixing device, the consumed power is increased.

The unit price of recording paper is the price of one sheet of recording paper. Because the purchase prices of the recording paper are different according to the company which sells the recording paper, the unit prices for the respective paper qualities and the respective recording paper sizes are previously set and registered in another table. The unit price for the paper quality and the recording paper size of the paper used in the printing, is read out from the table and is registered in the column of the unit price of recording paper in the print result DB 30.

The maintenance cost indicates that the maintenance cost to be burdened due to the printing. In case of the print processing apparatus 10, such as a multi function peripheral, normally, the maintenance contract in which the several tens of thousands of yen is paid for 100,000 copies, is closed. Therefore, the value obtained by multiplying the maintenance fee for one sheet by the number of sheets for which the printing is carried out, is registered as the maintenance cost. Because the maintenance fees for one sheet are different according to the maintenance contract, the maintenance fee for one sheet is registered separately. The value obtained by multiplying the number of sheets for which the printing is carried out, by the above registered maintenance fee, is registered as the result value of the maintenance cost in the print result DB 30.

Further, in the print result DB 30, the result value of each eco mode (saving item), which is obtained by executing the print job, is registered for each print job. That is, the result value of the total consumed power, the result value of the amount of toner consumption, the result value of the recording paper cost, the result value of the total cost and the result value of the emission amount of carbon dioxide, are calculated and registered.

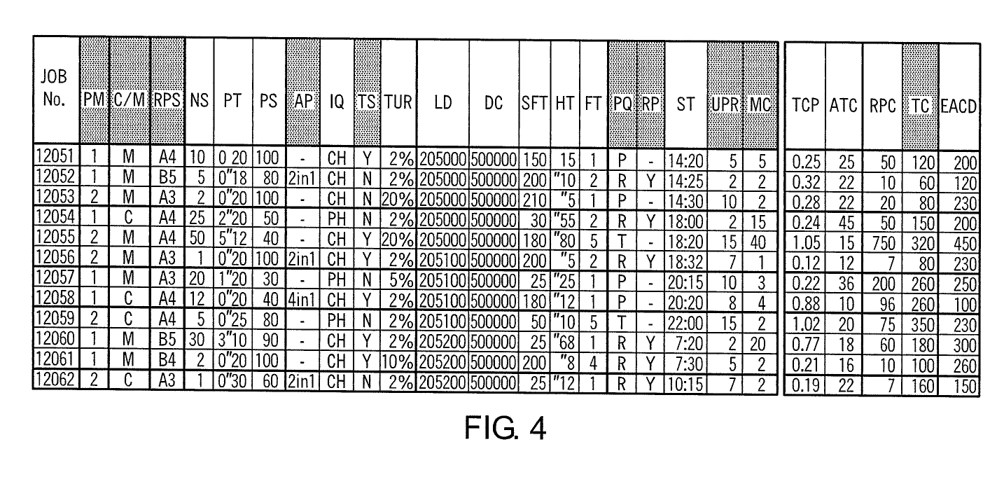

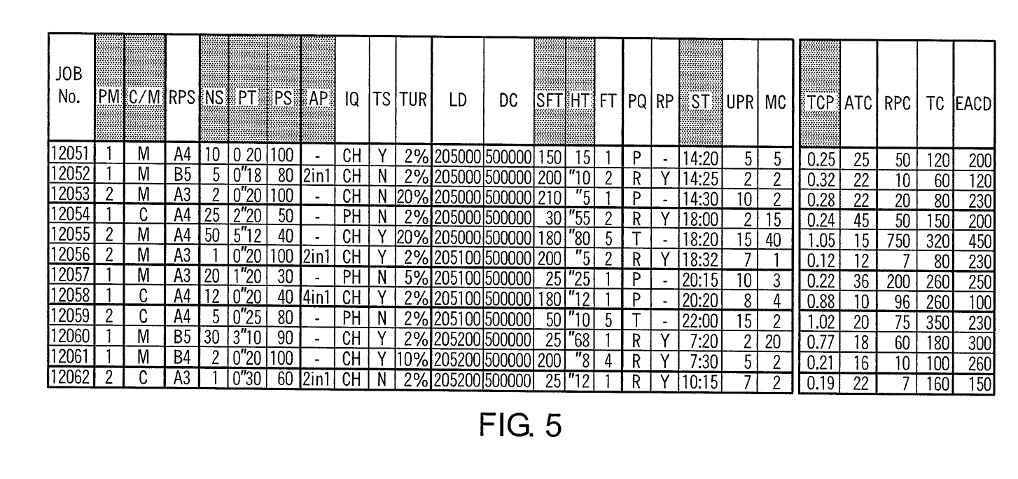

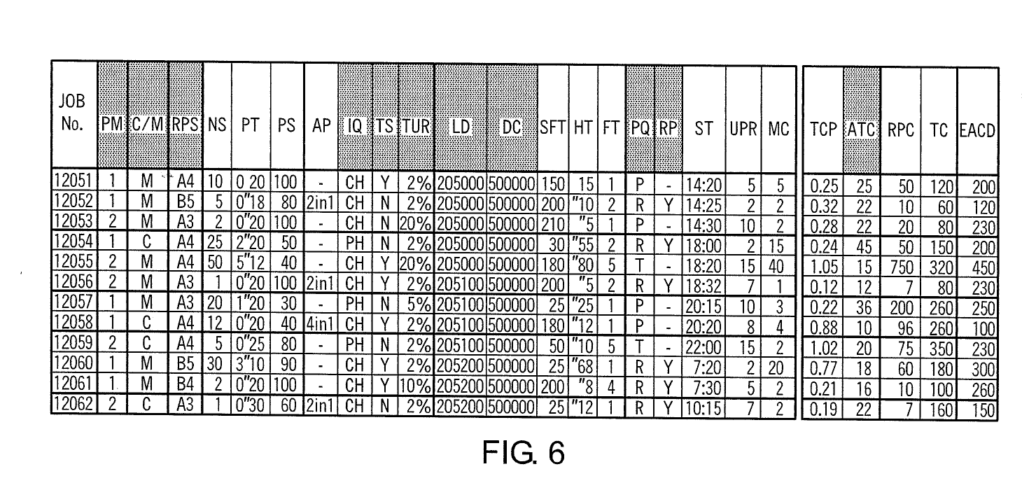

FIG. 4 shows the parameters relating to the calculation of the total cost in gray. FIG. 5 shows the parameters relating to the calculation of the total consumed power in gray. FIG. 6 shows the parameters relating to the calculation of the amount of toner consumption in gray.

Next, the process for calculating the recommendation print conditions, will be explained.

When the print is carried out, all of the collectable data are stored for each job as shown in FIG. 3. The respective result values of all of “total consumed power”, “amount of toner consumption”, “recording paper cost”, “total cost” and “emission amount of carbon dioxide” are calculated from the data obtained by executing the job, and are cumulatively stored in the print result DB 30. In the print result DB 30, in order to obtain the suitable statistical results, the data relating to a certain number or more of jobs are stored.

The amount of toner consumption is calculated by detecting the toner usage rate of each print page. Further, the amount of toner consumption may be calculated by estimating the amount of toner consumption from the count value of the toner supply. The recording paper cost is calculated, for example, by checking and registering the unit prices for the respective paper qualities and the respective recording paper sizes and by reading the unit price of the recording paper which is actually used, to multiply the number of used sheets of the recording paper by the read unit price.

The total cost is calculated by using the equation, such as (consumed power)×(unit price of electric power)+(amount of toner consumption)×(unit price of toner)+(recording paper cost)+(maintenance cost)+(supplies cost). The unit price of electric power is calculated in accordance with the rate schedules for the respective time zones and for the respective seasons, which are obtained from an electric power company, and the time and date at which the job is actually executed. The consumed power is measured by a power measurement unit provided in the print processing apparatus 10. The maintenance cost and the unit price of each supply (drum, developer and the like) are changed according to the contract. Further, because there are contracts in which the supplies cost is included in the maintenance cost, the method for calculating the total cost is adjusted according to the contract.

Next, the print conditions (print parameters) which possibly influence the result value of each saving item largely are previously determined, and the CPU 11 measures the contribution degree (degree of influence) of each input print parameter to the output value. For example, in case that the input paper parameter is the recording paper size, when the recording paper size is changed, the CPU 11 examines the change in the total cost which is the output value, in accordance with the data stored in the print result DB 30.

The contribution degree (degree of influence) is an index for judging the print condition (print parameter) to be changed in order to satisfy the user's request. For example, the contribution degree of a certain print condition to the total cost is calculated as the average value of (amount of change in the total cost)/(amount of change in the input print condition).

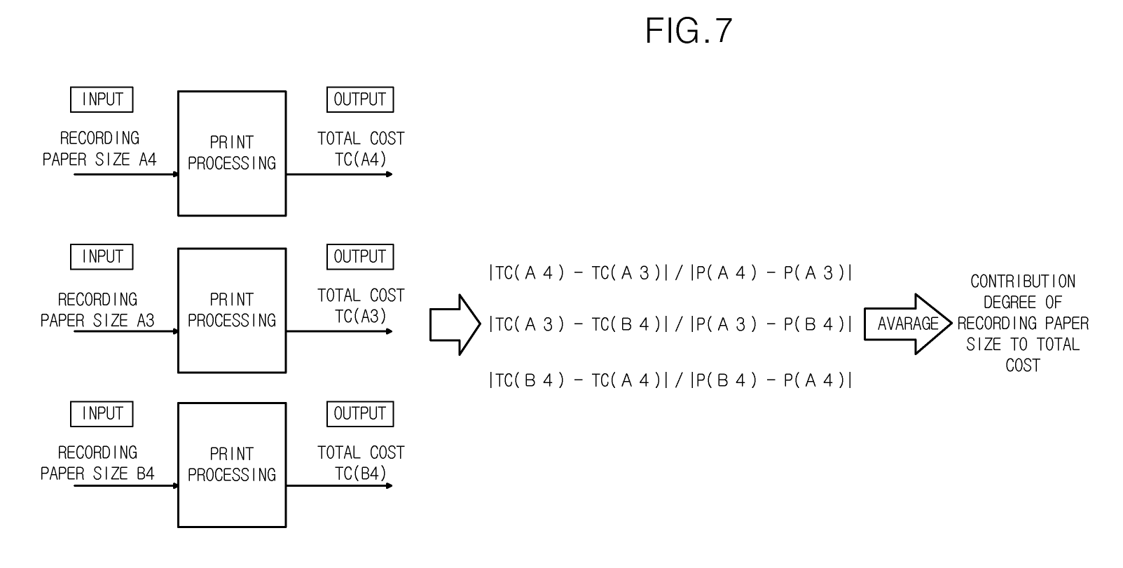

FIG. 7 shows the method for calculating the contribution degree of the recording paper size to the total cost. The recording paper size includes A4 size (210 mm×297 mm), A3 size (297 mm×420 mm) and B4 size (257 mm×364 mm). The recording paper cost of A4 size is P(A4), the recording paper cost of A3 size is P(A3) and the recording paper cost of B4 size is P(B4).

Firstly, the total cost TC(A4) which is caused when A4 size paper is used, the total cost TC(A3) which is caused when A3 size paper is used, and the total cost TC(B4) which is caused when B4 size paper is used, are calculated from the data registered in the print result DB 30.

Next, the first value is calculated by dividing the absolute value of (TC(A4)−TC(A3)) by the absolute value of (P (A4)−P(A3)). The second value is calculated by dividing the absolute value of (TC(A3)−TC(B4)) by the absolute value of (P(A3)−P(B4)). The third value is calculated by dividing the absolute value of (TC(B4)−TC(A4)) by the absolute value of (P(B4)−P(A4)). The average value of the first, the second and the third values is calculated as the contribution degree. That is, the first value is calculated by dividing the difference between the total cost caused when A4 size paper is used and the total cost caused when A3 size paper is used, by the difference between the recording paper cost of A4 size and the recording paper cost of A3 size. The second value is calculated by dividing the difference between the total cost caused when A3 size paper is used and the total cost caused when B4 size paper is used, by the difference between the recording paper cost of A3 size and the recording paper cost of B4 size. The third value is calculated by dividing the difference between the total cost caused when B4 size paper is used and the total cost caused when A4 size paper is used, by the difference between the recording paper cost of B4 size and the recording paper cost of A4 size. The average value of the first, the second and the third values is calculated as the contribution degree of the recording paper size to the total cost.

Hereinafter, in case that the total cost is selected as the saving item, the recommendation print conditions are calculated from the information stored in the print result DB 30, as follows. As described above, the CPU 11 calculates the contribution degree of each of a plurality of print parameters which are previously determined as the parameters which possibly influence the total cost largely, in accordance with the information recorded in the print result DB 30 of the hard disk drive 19. Further, the CPU 11 which functions as the recommendation print condition determining unit, selects several print parameters among the print parameters which are previously determined, in order of larger contribution degree (higher degree of influence on the change in the result value of the selected eco mode (saving mode)).

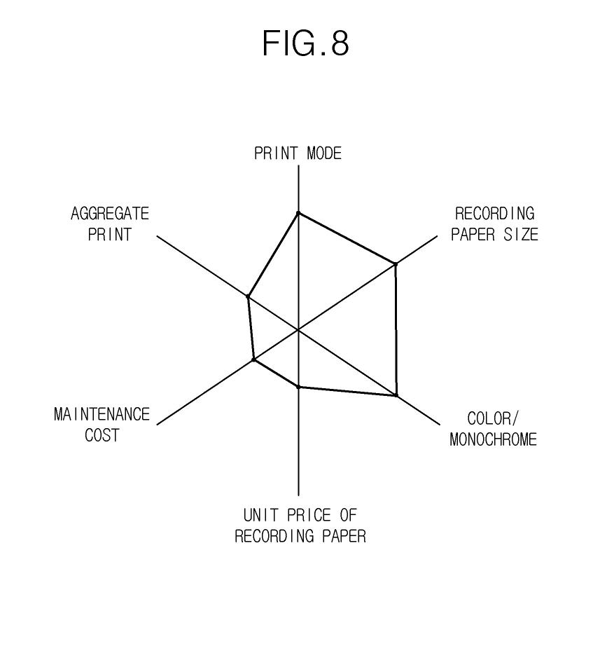

FIG. 8 shows the contribution degree of each print parameter to the total cost by the radar chart. As shown in FIG. 8, it is considered that three print parameters, print mode, recording paper size and color/monochrome are dominant in the total cost which is caused in the printing. Then, the CPU 11 sets the dominant print parameters to the print parameters for determining the recommendation print conditions. Thereby, it is possible to effectively optimize the total cost only by changing the setting of fewer print parameters.

Next, as the recommendation print condition determining unit, the CPU 11 calculates the optimal value of each of the print parameters for determining the recommendation print conditions from the result values and the like stored in the print result DB 30.

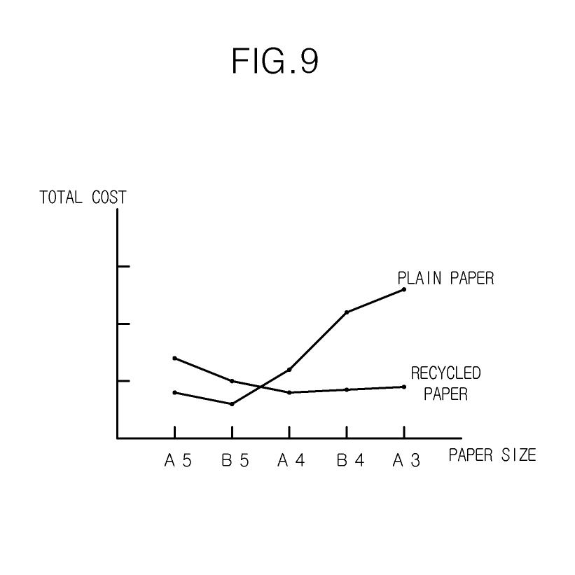

FIG. 9 is a graph showing the relations between the recording paper size and the total cost, which are calculated for the plain paper and the recycled paper, respectively, from the result values and the like stored in the print result DB 30. In case of the plain paper, when the paper having B5 size (182 mm×257 mm) is used, the total cost is the lowest. In case of the recycled paper, even though the recording paper size becomes larger, the cost is not particularly increased. Therefore, in case that the plain paper is used, B5 size is set to the recommended recording paper size. In case that the recycled paper is used, A4 size is set to the recommended recording paper size, or it is recommended that the recording paper having A3 size is used and 2in1 print is carried out by using the aggregate function, as the recommendation print conditions. The aggregate function is a function of printing a plurality of pages on one sheet of recording paper by reducing the images. Incase of Nin1 print, images of N pages are printed on one page by reducing the images.

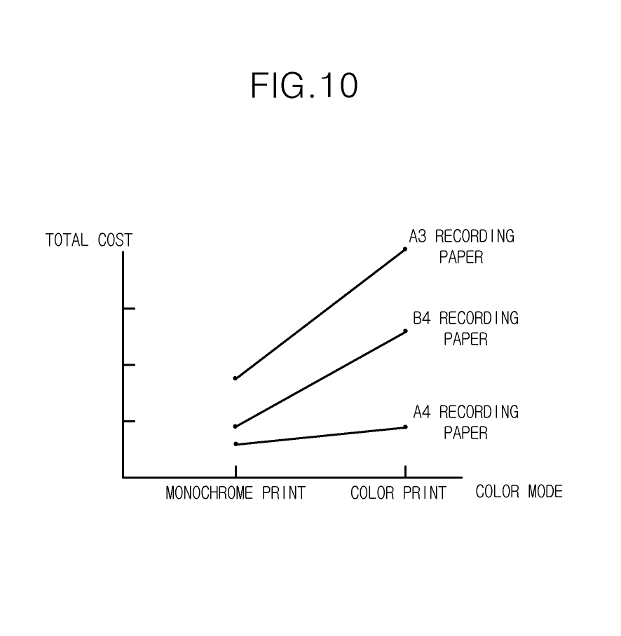

FIG. 10 is a graph showing the relations between the color/monochrome mode and the total cost, which are calculated for the respective recording paper sizes from the result values and the like stored in the print result DB 30. In case of A4 size, the cost difference between the color print and the monochrome print is small. As the recording paper size becomes larger, in case of the color print, it is found that the cost is largely increased. Therefore, in case the recording paper having A3 size is used, the monochrome print is recommended.

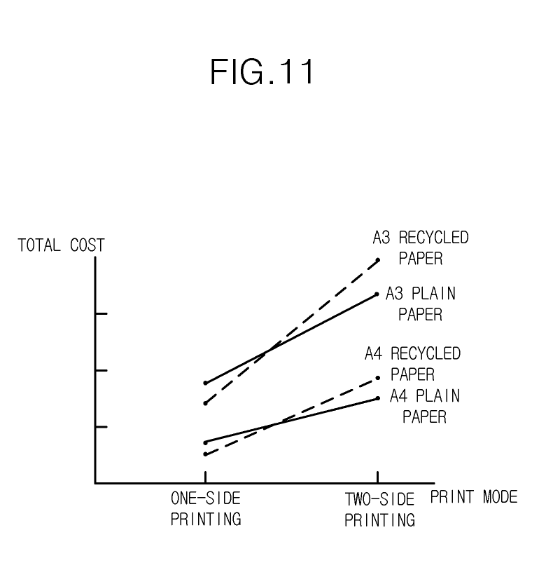

FIG. 11 is a graph showing the relations between the one-side printing/two-side printing mode and the total cost, which are calculated for A3 recycled paper, A3 plain paper, A4 recycled paper and A4 plain paper, respectively, from the result values and the like stored in the print result DB 30. In case of A3 recycled paper, because the cost difference between the two-side printing and the one-side printing is larger, the one-side printing is recommended when the A3 recycled paper is used.

By the above-described method, the CPU 11 calculates the respective optimal values of several print parameters having the large contribution degrees, for the saving item selected by a user (value of each of the several print parameters, which optimizes the result value of the saving item), as the recommendation print conditions.

### Second Embodiment

In the second embodiment, the print processing apparatus 10 determines the recommendation print conditions and transmits them to the printer driver of the user PC. Then, the print processing apparatus 10 instructs the printer driver to display the recommendation print conditions on the printer driver window (shows the recommendation print conditions to a user), and receives the acceptance of the recommendation print conditions from the user. The other configurations of the print processing apparatus 10 according to the second embodiment are the same as those of the print processing apparatus 10 according to the first embodiment. The explanations thereof are omitted.

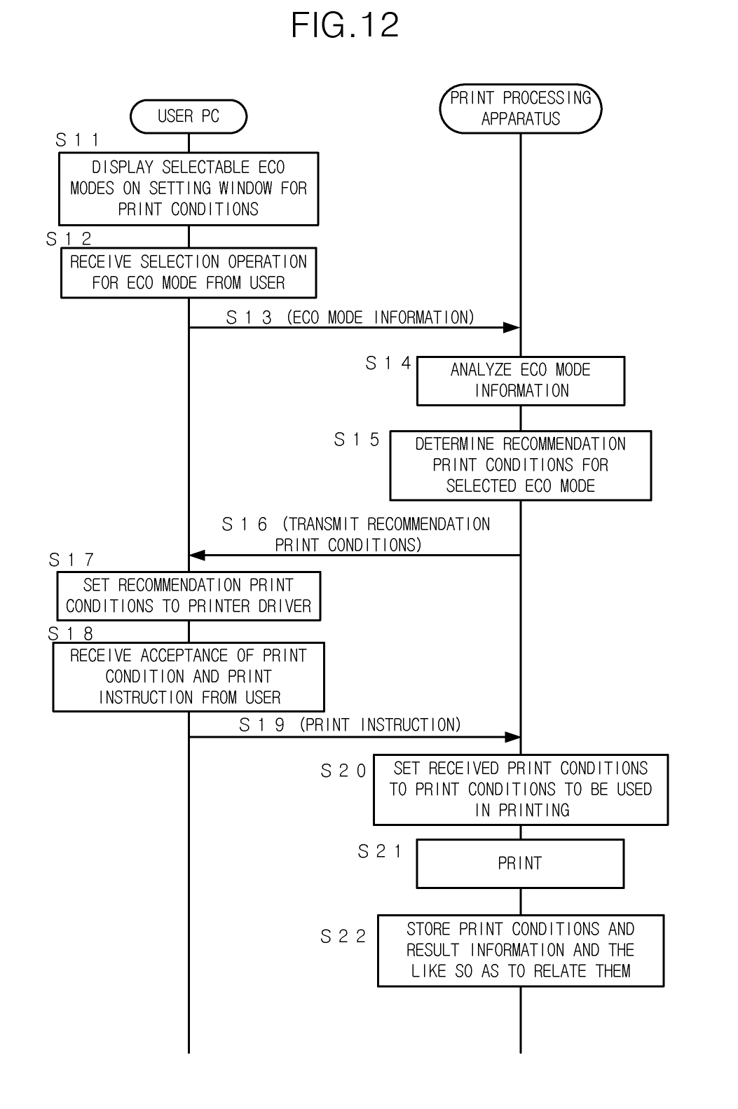

FIG. 12 shows the process sequence in case that the print processing apparatus 10 according to the second embodiment receives a print job from the user PC connected to a network and carries out printing.

Like the first embodiment, when the user instructs the print processing apparatus 10 to carry out the printing, the printer driver of the user PC displays a plurality of selectable eco modes (saving items) on the setting window for setting the print conditions (S11). When the printer driver receives the selection operation for selecting one eco mode among the selectable eco modes, from the user (S12), the printer driver transmits the information indicating the selected eco mode to the print processing apparatus 10 (S13).

The network communication unit 21 of the print processing apparatus 10 receives the print instruction including the information indicating the selected eco mode, from the user PC. That is, the network communication unit 21 has a function as the selection receiving unit for receiving the selection of the prior eco mode (saving item) among a plurality of eco modes (saving items), from the user PC (user). The CPU 11 of the print processing apparatus 10 analyzes the received information (S14), and determines one or more recommendation print conditions which are the most suitable for the eco mode selected by the user (which increase the saving effect of the selected saving item), in accordance with the result values and the like which are obtained by the printing carried out for a certain term and are stored in the print result DB 30 of the print processing apparatus 10 (S15). That is, the CPU 11 functions as the recommendation print condition determining unit. Further, as the recommendation print condition reflecting unit, the CPU 11 transmits the determined recommendation print conditions to the user PC to inform them of the user (S16). Thereby, the print processing apparatus 10 shows the recommendation print conditions to the user.

The user PC which receives the recommendation print conditions, sets the received recommendation print conditions as the print conditions of the print driver, and displays the set recommendation print conditions on the printer driver window (S17). The user visually confirms the recommendation print conditions which are displayed on the printer driver window. In case that the user accepts the recommendation print conditions without any problem, the user instructs the starting of the printing (S18). The user PC transmits the print instruction including the print conditions which are confirmed and accepted, to the print processing apparatus 10 (S19).

The printer driver of the user PC holds the recommendation print conditions which are received from the print processing apparatus 10, as the default print conditions for the selected eco mode. In the subsequent printing, only by designating the selected eco mode, the default print conditions are displayed as the predetermined print conditions. The default print conditions are held for each eco mode. When the eco mode is selected, the default values corresponding to the selected eco mode are set. That is, the CPU 11 of the print processing apparatus 10 has a function as the driver setting unit for transmitting the recommendation print conditions as the default print conditions to the printer driver of the user PC and for setting the recommendation print conditions.

The CPU 11 of the print processing apparatus 10 which receives the print instruction, sets the print conditions included in the received print instruction, as the print conditions to be used in the printing (S20). The image print unit 17 carries out the printing under the above print conditions (S21).

When the printing is finished, the print processing apparatus 10 which receives the print instruction, relates the print conditions used in the printing to the result information for all of the eco modes, which is obtained by the printing, and stores the print conditions and the result information in the print result DB 30 of the hard disk drive 19 as the result recording unit of the print processing apparatus 10 (S22).

As described above, the print processing apparatus 10 according to the second embodiment, automatically determines the recommendation print conditions for the eco mode selected by the user, in accordance with the result values and the like, which are obtained by the printing carried out for a certain term, and informs the user of the determined recommendation print conditions. In case that the user confirms the recommendation print conditions and the acceptance of the recommendation print conditions is received from the user, the print processing apparatus 10 carries out the printing under the accepted print conditions. Therefore, by only selecting the eco mode, the user can instruct the print processing apparatus 10 to carry out the printing under the print conditions which are the most suitable for the selected eco mode. It is not necessary to carry out the detail setting change of each print condition. The troublesome task for setting the print conditions is reduced. Further, because the recommendation print conditions are determined in accordance with the result values obtained by the past printing, the optimal print conditions according to the actual usage situation are determined as the recommendation print conditions. Further, because the user confirms the recommendation print conditions, the printing is not carried out under the print conditions which are not accepted by the user. In case that the recommendation print conditions are undesirable, optional print conditions may be set by using the printer driver window.

### Third Embodiment

In the third embodiment, the print processing apparatus 10 determines the recommendation print conditions within the respective allowable ranges which are previously set. The other configurations of the print processing apparatus 10 according to the third embodiment are the same as those of the print processing apparatus 10 according to the first embodiment. The explanations thereof are omitted.

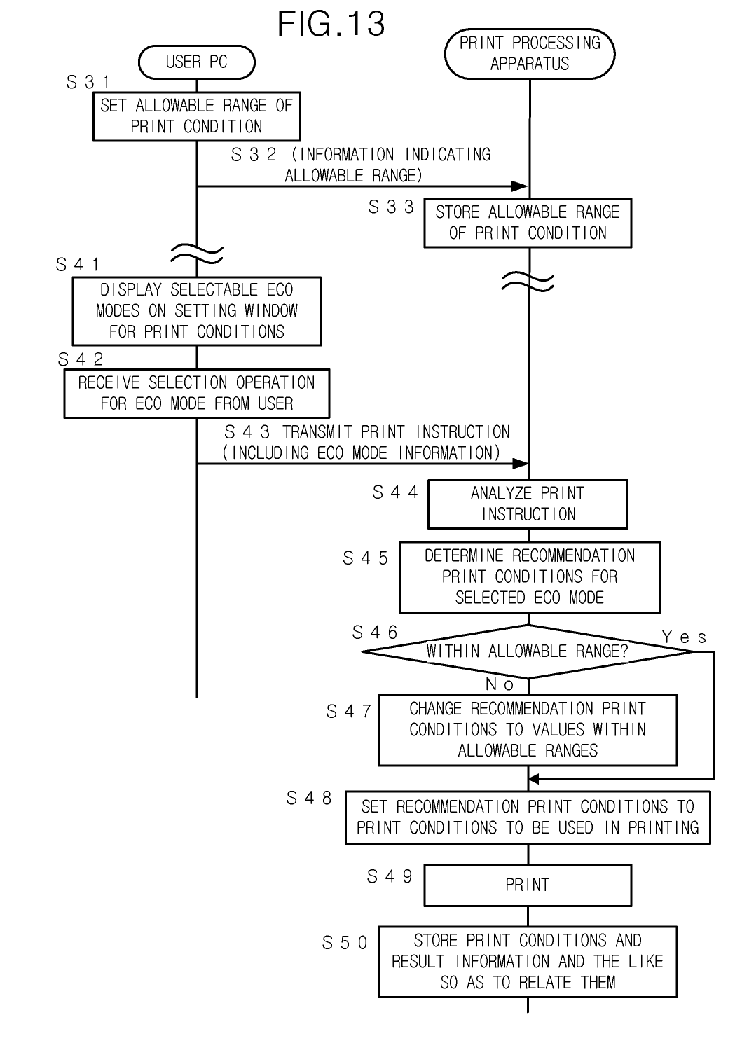

FIG. 13 shows the process sequence in case that the print processing apparatus 10 according to the third embodiment receives a print job from the user PC connected to a network and carries out printing. Before the printing is carried out, the user sets the allowable range of each print condition. The setting is received on the predetermined setting window of the printer driver (S31). The printer driver of the user PC transmits the information indicating the allowable range of each print condition, to the print processing apparatus 10 (S32). The print processing apparatus 10 which receives the above information, stores the allowable range of each print condition (S33).

The allowable ranges can be set for the respective print parameters of the print conditions. For example, in case that the user who has his/her demand that it is not preferred to change the one-side printing/two-side printing mode to “two-side printing” because the sheets in which the printing has been carried out for the front surface and has not been carried out for the rear surface are used for the printing in his/her office, sets the allowable range of the print parameter “one-side printing/two-side printing” to “one-side printing”, it is possible to prohibit the print parameter “one-side printing/two-side printing” from being changed to “two-side printing”. The allowable range may be commonly used in all of the eco modes. Alternatively, the setting of the allowable range for each eco mode may be received.

In this embodiment, the respective allowable ranges of at least print image size, color tone, toner concentration, color/monochrome setting, one-side printing/two-side printing and print speed among the print conditions, can be set. In addition, the respective allowable ranges of the reduction ratio, the aggregate print and the like can be set.

When the user who operates the user PC instructs the print processing apparatus 10 to print a file or the like, the user sets one or more print conditions to the setting window for setting the print conditions (printer driver window). At this time, the printer driver displays a plurality of selectable eco modes (saving items) on the setting window for setting the print conditions (S41). In this embodiment, like the first embodiment, the consumed power saving priority mode, the toner saving priority mode, the recording paper saving priority mode, the total cost saving priority mode and the carbon dioxide emission saving priority mode are displayed as the selectable eco modes.

The printer driver receives the selection operation for selecting one eco mode among the above-described eco modes, from the user. Further, when the printer driver receives the instruction for starting the printing from the user (S42), the printer driver of the user PC transmits the print instruction including the information indicating the selected eco mode to the print processing apparatus 10 (S43).

The network communication unit 21 of the print processing apparatus 10 receives the print instruction including the information indicating the selected eco mode, from the user PC. That is, the network communication unit 21 has a function as the selection receiving unit for receiving the selection of the prior eco mode (saving item) among a plurality of eco modes (saving items), from the user PC (user). The CPU 11 of the print processing apparatus 10 analyzes the received print instruction (S44), and determines one or more print conditions which are the most suitable for the eco mode selected by the user (which increase the saving effect of the selected saving item) (referred to as “recommendation print condition (s)”), in accordance with the result values and the like which are obtained by the printing carried out for a certain term and are stored in the print result DB 30 of the print processing apparatus 10 (S45). That is, the CPU 11 functions as the recommendation print condition determining unit. Further, as the recommendation print condition determining unit, the CPU 11 judges whether the determined recommendation print conditions are within the respective allowable ranges of the print conditions (S46). When the recommendation print conditions are within the respective allowable ranges (S46; Yes), the sequence proceeds to S48. When the recommendation print conditions are not within the allowable ranges (S46; No), the CPU 11 changes the recommendation print conditions to the values which are within the allowable ranges (S47). Then, the sequence proceeds to S48. For example, in case that the recommendation print condition exceeds the upper limit of the allowable range, the recommendation print condition is changed to the upper limit. In case that the recommendation print condition is lower than the lower limit of the allowable range, the recommendation print condition is changed to the lower limit. In case that the allowable range is set for each eco mode, the recommendation print condition is changed so as to be within the allowable range corresponding to the selected eco mode.

In S48, as the recommendation print condition determining unit, the CPU 11 sets the recommendation print conditions which are within the respective allowable ranges, as the print conditions to be used in the printing. Then, the image print unit 17 carries out the printing under the set recommendation print conditions (S49).

When the printing is finished, the print processing apparatus 10 relates the print conditions used in the printing to the result information for all of the eco modes, which is obtained by the printing, and stores the print conditions and the result information in the print result DB 30 of the hard disk drive 19 as the result recording unit of the print processing apparatus 10 (S50).

As described above, in the print processing apparatus 10 according to the third embodiment, the recommendation print conditions are limited to the respective allowable ranges which are previously set. Therefore, while the printing is prevented from being carried out under the print conditions which are not preferred for the user, the saving effect is obtained within the allowable ranges. For example, the print image is prevented from being small out of the allowable range by excessively prioritizing the settings corresponding to the eco mode. Further, the two-side printing is prevented from being carried out for the sheet which is not suitable for the two-side printing by excessively prioritizing the settings corresponding to the eco mode.

### Fourth Embodiment

In the fourth embodiment, the management server 60 which is connected to the print processing apparatus 10B via a network, prepares and stores the print result DB 30 and determines the recommendation print conditions. That is, the management server 60 has a function as the print condition recommendation device.

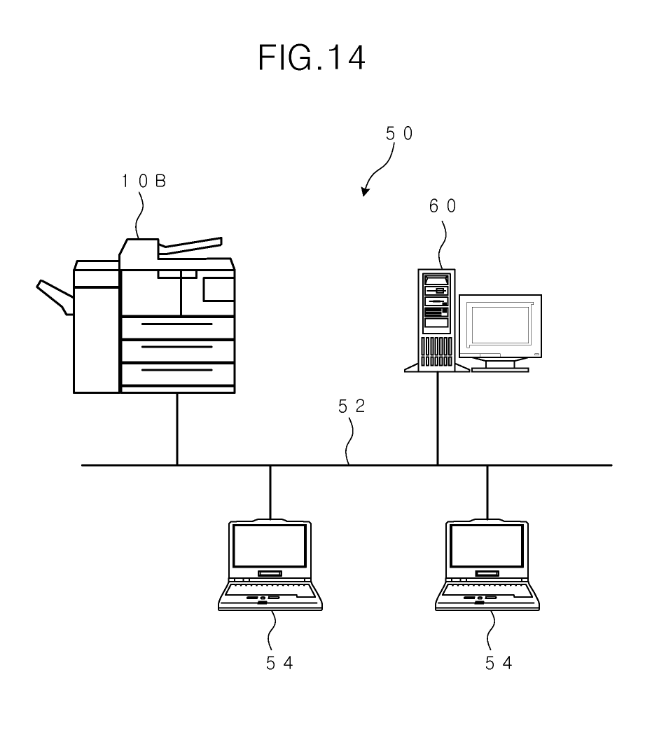

FIG. 14 shows an example of the print system 50 in which the print processing apparatus 10B and the management server 60 are connected via a network 52, such as a LAN (Local Area Network) or the like. The print processing apparatus 10B has substantially the same configuration as the print processing apparatus 10 according to the first embodiment. However, the print result DB 30 is not prepared in the hard disk drive 19. In addition, a plurality of user PCs 54 are connected via the network 52.

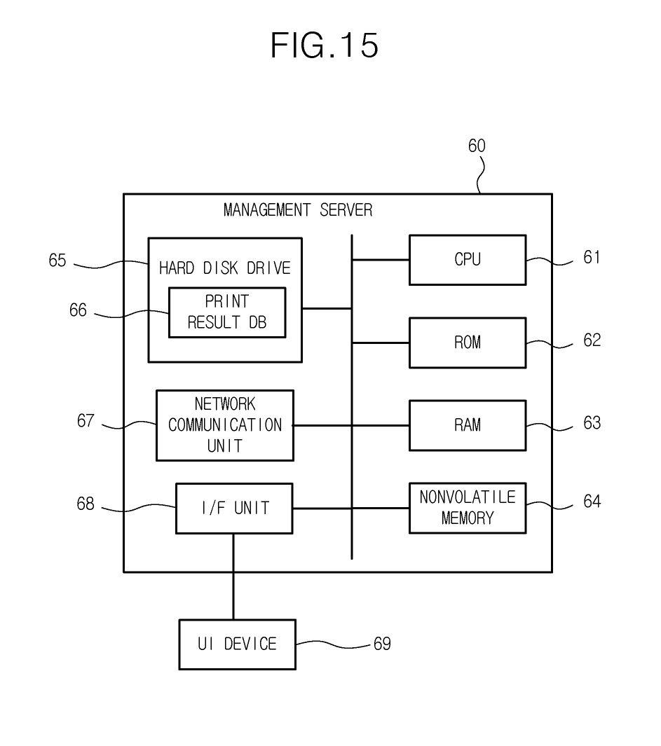

FIG. 15 shows the electrical schematic structure of the management server 60. The management server 60 is configured by connecting a CPU 61 for controlling the operation of the management server 60 with a ROM 62, a RAM 63, a nonvolatile memory 64, a hard disk drive 65, a network communication unit 67, an I/F (Interface) unit 68 and the like via a bus.

In the ROM 62, various types of programs and data are stored. By executing various types of processes by the CPU 61 in accordance with these programs, various types of functions of the management server 60 are realized. The RAM 63 is used as a work memory for temporarily storing various types of data when the CPU 61 executes the programs.

The nonvolatile memory 64 is a memory in which the stored contents are held even if the management server 60 is turned off. In the nonvolatile memory 64, various types of setting information, user information, communication information (network addresses and the like) and the like are stored.

In the hard disk drive 65, the print result DB 66 which is the same as the print result DB 30 according to the first embodiment, is provided. However, in the print result DB 66, the result information and the like obtained by the printing carried out by a plurality of print processing apparatuses 10B which are managed by the management server 60, are stored. That is, as the result recording unit, the hard disk drive 65 records the print conditions used in the printing carried out by a plurality of print processing apparatuses 10B (print apparatuses) connected via the network and the result information obtained by the printing carried out by a plurality of print processing apparatuses 10B, so as to relate the print conditions to the result information.

The network communication unit 67 has a function of communicating with the print processing apparatuses 10B, the user PCs 54 and the other external devices via the network 52. The I/F unit 68 is connected with the UI (User Interface) device 69, such as a display, a keyboard or the like. The management server 60 may be configured by installing a predetermined program on a generic server.

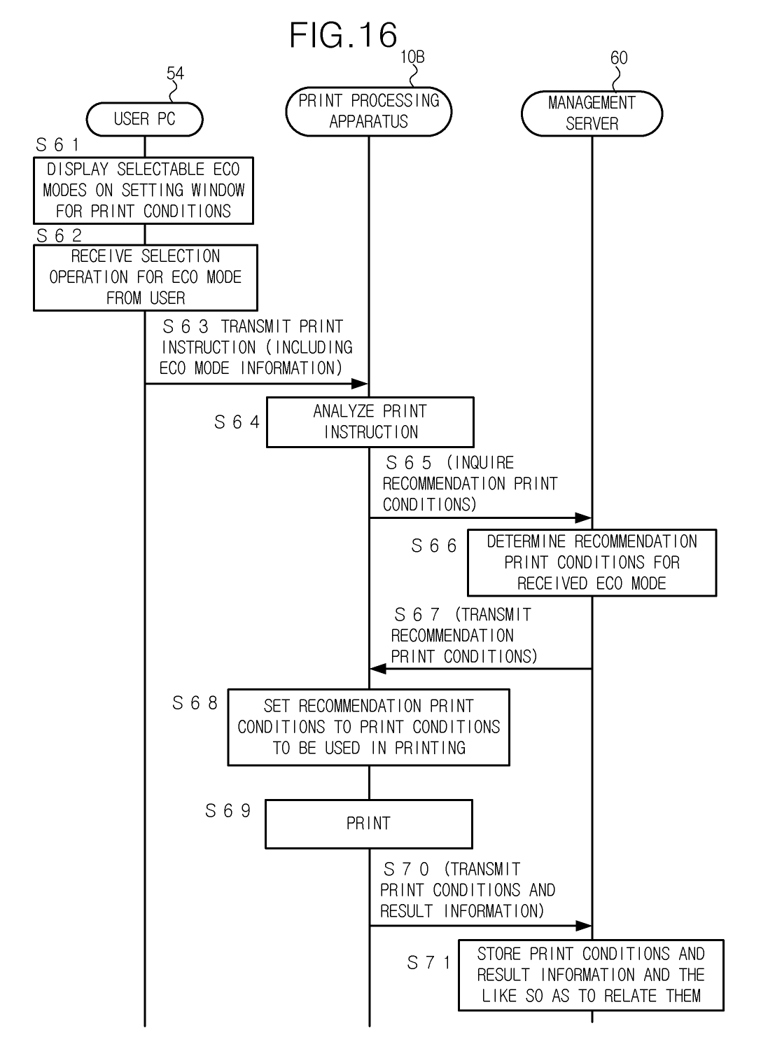

FIG. 16 shows the process sequence in case that the printing is carried out in the print system 50 according to the fourth embodiment. Like the first embodiment, when the user instructs the print processing apparatus 10B to carry out the printing, the printer driver of the user PC 54 displays a plurality of selectable eco modes (saving items) on the setting window for setting the print conditions (S61). When the printer driver receives the selection operation for selecting one eco mode among the selectable eco modes, from the user (S62), the printer driver transmits the information indicating the selected eco mode to the print processing apparatus 10B (S63).

The print processing apparatus 10B analyzes the received information (S64), and transmits the eco mode selected by the user, the designated print conditions and the like to the management server 60 to inquire the recommendation print conditions of the management server 60 (S65).

The network communication unit 67 of the management server 60 receives the eco mode selected by the user, the designated print conditions and the like. That is, the network communication unit 67 has a function as the selection receiving unit for receiving the selection of the prior eco mode (saving item) among a plurality of eco modes (saving items), from the user. The CPU 61 of the management server 60 which receives the above inquiry, determines one or more recommendation print conditions which are the most suitable for the eco mode designated in the above inquiry (which increase the saving effect of the selected saving item), in accordance with the result values and the like which are obtained by the printing carried out for a certain term and are stored in the print result DB 66 of the management server 60 (S66). That is, the CPU 61 functions as the recommendation print condition determining unit. Then, the management server 60 transmits the determined recommendation print conditions to the print processing apparatus 10B (S67).

The print processing apparatus 10B which receives the determined recommendation print conditions, sets the received recommendation print conditions as the print conditions to be used in the printing (S68), and carries out the printing (S69). That is, the CPU 61 of the management server 60 has a function as the recommendation print condition reflecting unit for setting the above recommendation print conditions to the print processing apparatus 10B.

When the printing is finished, the print processing apparatus 10B transmits the print conditions used in the printing and the result information for all of the eco modes, which is obtained by the printing, to the management server 60 (S70). The management server 60 which receives the print conditions and the result information, relates the print conditions to the result information for the respective eco modes and stores the received print conditions and the result information in the print result DB 66 of the hard disk drive 65 as the result recording unit of the management server 60 (S71).

The print system 50 in which each print processing apparatus 10B transmits the print conditions and the basic data for calculating the result values to the management server 60 and the management server 60 calculates the result value (the total cost or the like) of each eco mode, may be configured.

Because the management server 60 stores the result information and the like obtained by the printing carried out by a plurality of print processing apparatuses 10B, it is possible to collect more data. Therefore, it is possible to calculate the recommendation print conditions more precisely in accordance with much result information and the like obtained by the printing carried out by a plurality of print apparatuses. Further, even though the number of times of printing carried out by a specific print processing apparatus 10B is low, it is possible to calculate the suitable recommendation print conditions in accordance with much result information and the like which is collected from a plurality of print processing apparatuses 10B in the print system 50.

### Fifth Embodiment

In the fifth embodiment, the management server 60 is not provided in the print system, and the information accumulated in the print result DB 30 is shared among a plurality of print processing apparatuses 10 connected via the network 52. That is, each print processing apparatus 10 uses the information recorded in the respective hard disk drives 19 (result recording unit) of the other print processing apparatuses 10 connected via the network 52. The other configurations of the print processing apparatus 10 according to the fifth embodiment are the same as those of the print processing apparatus 10 according to the first embodiment. Each print processing apparatus 10 has a function as the print condition recommendation device.

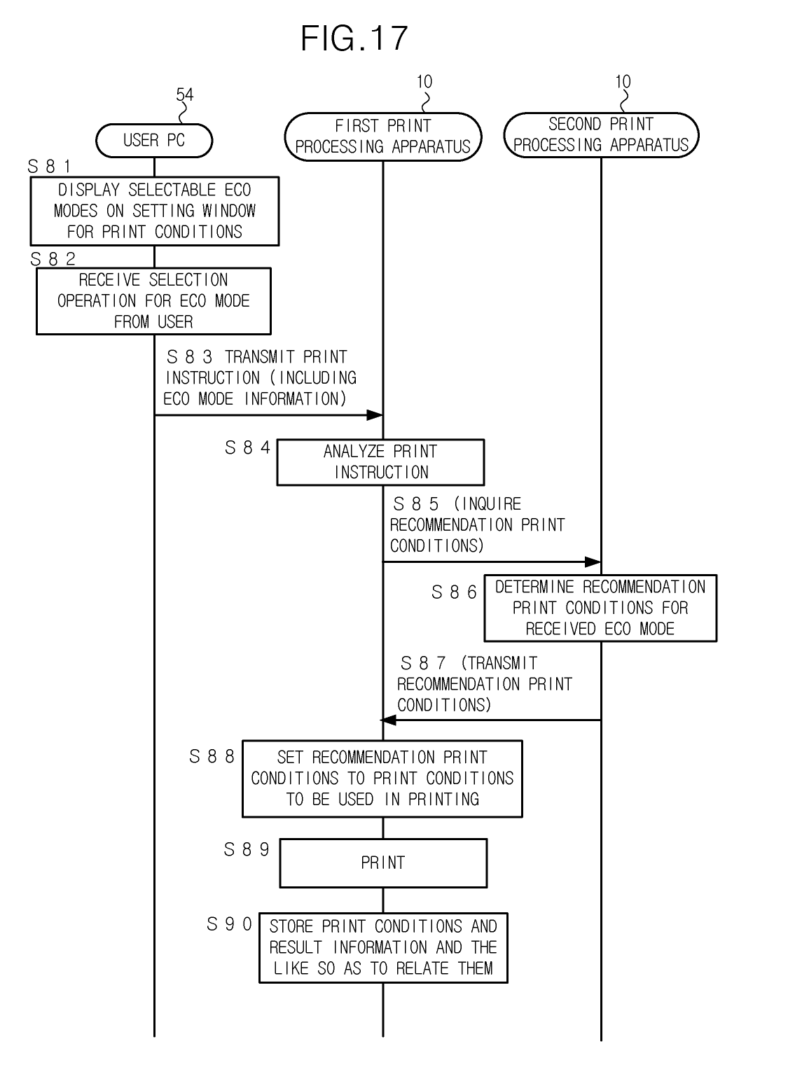

FIG. 17 shows the process sequence in case that the printing is carried out by the first print processing apparatus 10 according to the fifth embodiment. FIG. 17 shows the process sequence in which the first print processing apparatus 10 inquires the recommendation print conditions of the second print processing apparatus 10 which accumulates more result information and the like because the amount of result information and the like stored by the first print processing apparatus 10 is low.

Like the first embodiment, when the user instructs the first print processing apparatus 10 to carry out the printing, the printer driver of the user PC 54 displays a plurality of selectable eco modes (saving items) on the setting window for setting the print conditions (S81). When the printer driver receives the selection operation for selecting one eco mode among the selectable eco modes, from the user (S82), the printer driver transmits the information indicating the selected eco mode to the first print processing apparatus 10 (S83).

The first print processing apparatus 10 analyzes the received information (S84), and transmits the eco mode selected by the user, the designated print conditions and the like to the second print processing apparatus 10 to inquire the recommendation print conditions of the second print processing apparatus 10 (S85).

The CPU 11 of the second print processing apparatus 10 which receives the above inquiry, determines one or more recommendation print conditions which are the most suitable for the eco mode designated in the above inquiry (which increase the saving effect of the selected saving item), in accordance with the result values and the like which are obtained by the printing carried out for a certain term and are stored in the print result DB 30 provided in the hard disk drive 19 of the second print processing apparatus 10 as the result recording unit of another print processing apparatus (S86). Then, the second print processing apparatus 10 transmits the determined recommendation print conditions to the first print processing apparatus 10 (S87).

The first print processing apparatus 10 which receives the determined recommendation print conditions, sets the received recommendation print conditions as the print conditions to be used in the printing (S88), and carries out the printing (S89).

When the printing is finished, the first print processing apparatus 10 stores the print conditions used in the printing and the result information for all of the eco modes, which is obtained by the printing, in the print result DB 30 of the first print processing apparatus 10 (S90).

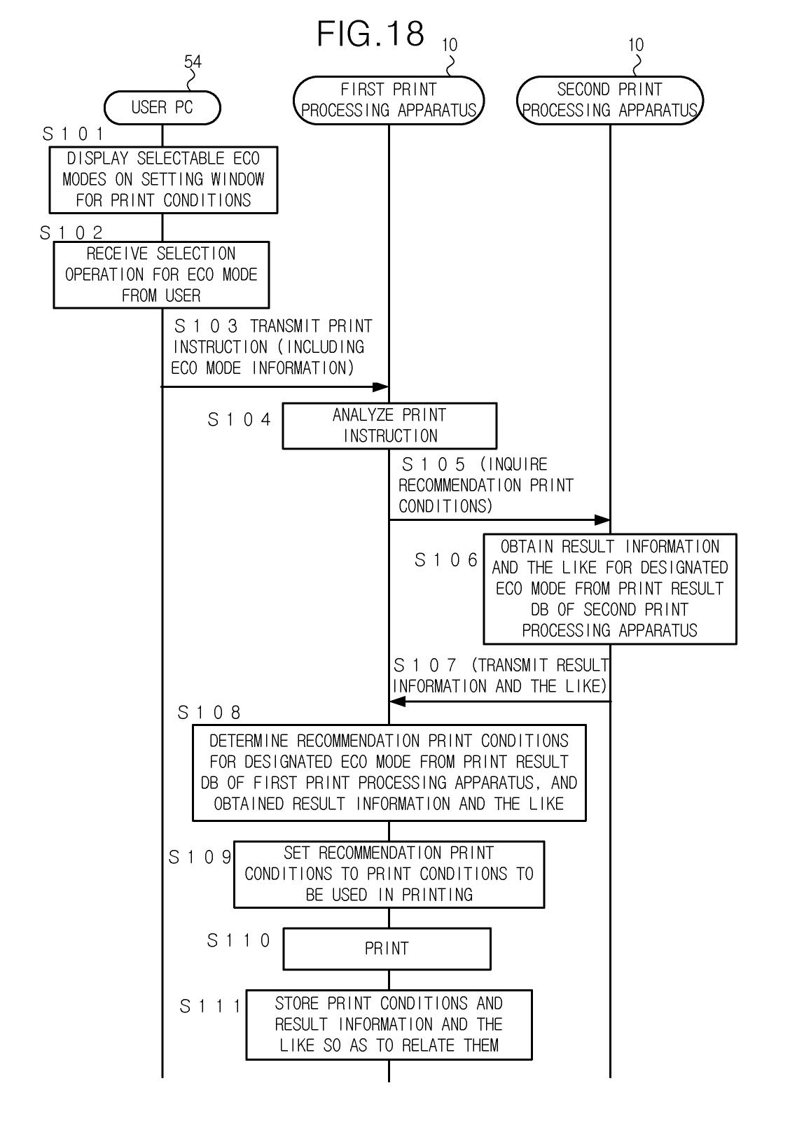

FIG. 18 shows another example of the process sequence in case that the printing is carried out by the first print processing apparatus 10 according to the fifth embodiment. FIG. 18 shows the process sequence in which the first print processing apparatus 10 obtains the result information and the like from the second print processing apparatus 10 and the first print processing apparatus 10 determines one or more recommendation result conditions in accordance with both of the result information and the like stored in the print result DB 30 of the first print processing apparatus 10 and the result information and the like obtained from the second print processing apparatus 10 because the amount of result information and the like stored by the first print processing apparatus 10 is low.

When the user instructs the first print processing apparatus 10 to carry out the printing, the printer driver of the user PC 54 displays a plurality of selectable eco modes (saving items) on the setting window for setting the print conditions (S101). When the printer driver receives the selection operation for selecting one eco mode among the selectable eco modes, from the user (S102), the printer driver transmits the information indicating the selected eco mode to the first print processing apparatus 10 (S103).

The CPU 11 of the first print processing apparatus 10 analyzes the received information (S104), and transmits the request for obtaining the result information and the like for the eco mode selected by the user, to the second print processing apparatus 10 (S105).

The second print processing apparatus 10 which receives the above request, reads out and obtains the result information and the like for the eco mode designated in the above request, from the print result DB 30 provided in the hard disk drive 19 of the second print processing apparatus 10 as the result recording unit of another print processing apparatus (S106). Then, the second print processing apparatus 10 transmits the obtained result information and the like to the first print processing apparatus 10 (S107). In this case, the second print processing apparatus 10 transmits the print conditions and the result information for the designated eco mode.

The first print processing apparatus 10 determines one or more recommendation print conditions for the eco mode selected by the user, in accordance with the received result information and the like and the information stored in the print result DB 30 of the first print processing apparatus 10 (S108). Then, the first print processing apparatus 10 sets the determined recommendation print conditions as the print conditions to be used in the printing (S109), and carries out the printing (S110).

When the printing is finished, the first print processing apparatus 10 stores the print conditions used in the printing and the result information for all of the eco modes, which is obtained by the printing, in the print result DB 30 of the first print processing apparatus 10 (S111).

As described above, because the print processing apparatus 10 according to the fifth embodiment, shears the information stored in the print result DB 30 with the other print processing apparatuses 10 connected via the network, it is possible to determine the suitable recommendation print conditions in accordance with more result information and the like. In the example of FIG. 18, the result information and the like is obtained from another one print processing apparatus 10. However, the result information and the like may be obtained from a plurality of print processing apparatuses 10 connected via the network.

As described above, the embodiments are explained by using the drawings. However, in the present invention, the concrete configuration is not limited to the above embodiments. In the present invention, various modifications of the above embodiments or the addition of various functions or the like to the embodiments can be carried out without departing from the gist of the invention.

Also in the second, the fourth and the fifth embodiments, the allowable ranges may be set in order to determine the recommendation print conditions within the respective allowable ranges. Further, also in the fourth and the fifth embodiments, like the second embodiment, the print processing apparatus may transmit the recommendation print conditions to the user PC in order to obtain the confirmation and the acceptance of the user.

The saving items described in the embodiments are merely examples. The saving item is not limited to those of the embodiments. Further, the method for calculating the result value of the saving item, which is described in the embodiments, is merely an example. The result value can be calculated by another method.

One of the objects of the above embodiments is to provide a print condition recommendation device, a print processing apparatus, a print condition recommendation method and a tangible computer-readable recording medium, which can determine one or more print conditions which are the most suitable for the saving item selected by a user, according to the actual usage situation and, for example, can show the determined print conditions to the user.

In at least one of the above embodiments, when the printing is carried out, the print condition recommendation device or the like records the print conditions used in the printing and the result information for a plurality of saving modes so as to relate the print conditions to the result information. Then, when the print instruction is received from a user, the print condition recommendation device or the like receives the selection of the saving item and determines one or more recommendation print conditions which increase the saving effect of the selected saving item in accordance with the result information recorded in the result recording unit. The print condition recommendation device or the like shows the determined recommendation print conditions to the user or automatically sets the determined recommendation print conditions to the print apparatus. Because the print conditions which increase the saving effect of the selected saving item are automatically calculated in accordance with the past results and are shown or set by selecting the saving item, it is possible to reduce the troublesome task for setting the optimal print conditions.

In at least one of the above embodiments, a plurality of saving items include at least two items of the consumed power, the amount of toner consumption (or the toner cost), the amount of recording paper consumption (or the recording paper cost), the total cost and the emission amount of carbon dioxide.

In at least one of the above embodiments, the print condition recommendation device or the like selects one or more print parameters which largely influence the result value of the saving item selected by the user, among a large number of print parameters. Then, the print condition recommendation device or the like calculates the optimal value of each selected print parameter (value which optimizes the result value of the saving item selected by the user), and determines the optimal values of the selected print parameters as the recommendation print conditions. That is, only fewer print parameters which are effective for the optimization of the result value of the saving item are set as the recommendation print conditions.

In at least one of the above embodiments, because the recommendation print conditions are set to the default values for the print driver, it is possible to easily set the suitable print conditions in the subsequent print setting.

In at least one of the above embodiments, in case that the print conditions are changed to the conditions which are not allowed by the user, the change of the print conditions is limited.

In at least one of the above embodiments, because the print condition recommendation device or the like records the result information and the like obtained by a plurality of print apparatuses connected via the network, it is possible to calculate the optimal recommendation print conditions in accordance with more result information and the like.

In at least one of the above embodiments, the print processing apparatus having the print unit determines one or more recommendation print conditions.

In at least one of the above embodiments, it is possible to determine one or more recommendation print conditions by using the information recorded in the result recording unit of another print processing apparatus.

According to the print condition recommendation device, the print processing apparatus, the print condition recommendation method and the tangible computer-readable recording medium, it is possible to determine one or more print conditions which are the most suitable for the saving item selected by a user, according to the actual usage situation and, for example, to show the determined print conditions to the user.

The present U.S. patent application claims the priority of Japanese Patent Application No. 2012-203861, filed on Sep. 18, 2012, according to the Paris Convention, and the entirety of which is incorporated herein by reference for correction of incorrect translation.

What is claimed is:

1. A print condition recommendation device, comprising:
a result recording unit to record a print condition used in printing carried out by a predetermined print apparatus, and result information which is one of a result value of each of a plurality of saving items which are previously determined and data for calculating the result value, so as to relate the print condition to the result information;
a selection receiving unit to receive a selection of a prior saving item among the plurality of saving items from a user;
a recommendation print condition determining unit to determine a recommendation print condition which is the print condition which increases a saving effect of the prior saving item received by the selection receiving unit, in accordance with the result information recorded in the result recording unit; and
a recommendation print condition reflecting unit to show the recommendation print condition determined by the recommendation print condition determining unit, to the user, or to set the recommendation print condition to the predetermined print apparatus.

2. The print condition recommendation device of claim 1, wherein the plurality of saving items include at least two items selected among consumed power, toner, recording paper, total cost and emission amount of carbon dioxide.

3. The print condition recommendation device of claim 1, wherein the recommendation print condition determining unit selects one or more print parameters having high degree of influence on change in the result value of the prior saving item received by the selection receiving unit, in accordance with the result information recorded in the result recording unit, and calculates a value of each selected print parameter, which optimizes the result value, as the recommendation print condition.

4. The print condition recommendation device of claim 1, further comprising a driver setting unit to transmit the recommendation print condition to a predetermined printer driver and to set the recommendation print condition to the predetermined printer driver as a default print condition.

5. The print condition recommendation device of claim 1, wherein the recommendation print condition determining unit determines the recommendation print condition within an allowable range which is previously set.

6. The print condition recommendation device of claim 1, wherein the result recording unit records the print condition used in the printing carried out by each of a plurality of print apparatuses connected via a network and the result information obtained by the printing, so as to relate the print condition to the result information.

7. A print processing apparatus, comprising:
the print condition recommendation device of claim 1; and
a print unit to function as the print apparatus.

8. The print processing apparatus of claim 7, wherein the print processing apparatus uses information recorded in a result recording unit of another print processing apparatus connected via a network.

9. A tangible computer-readable recording medium storing a program therein, wherein the program causes an information processing apparatus to function as a print condition recommendation device comprising:
a result recording unit to record a print condition used in printing carried out by a predetermined print apparatus, and result information which is one of a result value of each of a plurality of saving items which are previously determined and data for calculating the result value, so as to relate the print condition to the result information;
a selection receiving unit to receive a selection of a prior saving item among the plurality of saving items from a user;
a recommendation print condition determining unit to determine a recommendation print condition which is the print condition which increases a saving effect of the prior saving item received by the selection receiving unit, in accordance with the result information recorded in the result recording unit; and
a recommendation print condition reflecting unit to show the recommendation print condition determined by the recommendation print condition determining unit, to the user, or to set the recommendation print condition to the predetermined print apparatus.

10. The tangible computer-readable recording medium of claim 9, wherein the plurality of saving items include at least two items selected among consumed power, toner, recording paper, total cost and emission amount of carbon dioxide.

11. The tangible computer-readable recording medium of claim 9, wherein the recommendation print condition determining unit selects one or more print parameters having high degree of influence on change in the result value of the prior saving item received by the selection receiving unit, in accordance with the result information recorded in the result recording unit, and calculates a value of each selected print parameter, which optimizes the result value, as the recommendation print condition.

12. The tangible computer-readable recording medium of claim 9, wherein the program causes the information processing apparatus to function as the print condition recommendation device further comprising:
a driver setting unit to transmit the recommendation print condition to a predetermined printer driver and to set the recommendation print condition to the predetermined printer driver as a default print condition.

13. The tangible computer-readable recording medium of claim 9, wherein the recommendation print condition determining unit determines the recommendation print condition within an allowable range which is previously set.

14. The tangible computer-readable recording medium of claim 9, wherein the result recording unit records the print condition used in the printing carried out by each of a plurality of print apparatuses connected via a network and the result information obtained by the printing, so as to relate the print condition to the result information.

15. A tangible computer-readable recording medium storing a program therein, wherein the program causes a print apparatus to function as a print processing apparatus comprising:
a print unit;
a result recording unit to record a print condition used in printing carried out by the print unit, and result information which is one of a result value of each of a plurality of saving items which are previously determined and data for calculating the result value, so as to relate the print condition to the result information;
a selection receiving unit to receive a selection of a prior saving item among the plurality of saving items from a user;
a recommendation print condition determining unit to determine a recommendation print condition which is the print condition which increases a saving effect of the prior saving item received by the selection receiving unit, in accordance with the result information recorded in the result recording unit; and
a recommendation print condition reflecting unit to show the recommendation print condition determined by the recommendation print condition determining unit, to the user, or to set the recommendation print condition to the predetermined print apparatus.

16. The tangible computer-readable recording medium of claim 15, wherein the print processing apparatus uses information recorded in a result recording unit of another print processing apparatus connected via a network.

17. A print condition recommendation method, comprising:
recording a print condition used in printing carried out by a predetermined print apparatus, and result information which is one of a result value of each of a plurality of saving items which are previously determined and data for calculating the result value, so as to relate the print condition to the result information;
receiving a selection of a prior saving item among the plurality of saving items from a user;
determining a recommendation print condition which is the print condition which increases a saving effect of the received prior saving item, in accordance with the recorded result information; and
showing the determined recommendation print condition to the user, or setting the recommendation print condition to the predetermined print apparatus.

18. The print condition recommendation method of claim 17, wherein the plurality of saving items include at least two items selected among consumed power, toner, recording paper, total cost and emission amount of carbon dioxide.

19. The print condition recommendation method of claim 17, wherein in the determining of the recommendation print condition, one or more print parameters having high degree of influence on change in the result value of the received prior saving item, are selected in accordance with the recorded result information, and a value of each selected print parameter, which optimizes the result value, is calculated as the recommendation print condition.

20. The print condition recommendation method of claim 17, further comprising:
transmitting the recommendation print condition to a predetermined printer driver; and
setting the recommendation print condition to the predetermined printer driver as a default print condition.
